(19) United States
(12) Patent Application Publication
(10) Pub. No.: US 2002/0013437 A1
(43) Pub. Date: Jan. 31, 2002

(54) Low-viscosity polymers

(75) Inventors: Graham Edmund McKee, Neustadt (DE); Susanne Brinkmann-Rengel, Ober-Olm (DE); Eric Wassner, Mannheim (DE); Yulliang Yang, Shanghai (CN); Chengming Li, Shanghai (CN); Junpo He, Shanghai (CN); Yuefei Tao, Shanghai (CN); Zhongmin Wang, Shanghai (CN); Jingyun Pan, Shanghai (CN)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: BASF Aktiengesellschaft, Ludwigschafen (DE)

(21) Appl. No.: 09/891,191

(22) Filed: Jun. 26, 2001

(30) Foreign Application Priority Data
Jun. 27, 2000 (DE) 10031186.5

(51) Int. Cl. C08F 2/00; C08F 4/00

(52) U.S. Cl. 526/220

(57) ABSTRACT

Polymers obtainable by a process for the living free radical polymerization of one or more ethylenically unsaturated monomers with the use of at least one free radical polymerization initiator and in the presence of one or more stable N-oxyl radicals, at least one stable N-oxyl radical having polymerizable double bonds, are used for processing to give moldings, films, fibers and foams.

The present invention relates to the use of polymers obtainable by living free radical polymerization of ethylenically unsaturated monomers in the presence of a stable N-oxyl radical which has polymerizable double bonds, and polymers having low shear viscosity in the melt and to a process for their preparation.

Free radical polymerizations of monomers having at least one ethylenically unsaturated group have the disadvantage that the molecular weight of the polymer chains usually does not increase with the polymerization conversion and that the polymer chains of the resulting polymers generally do not have a uniform molecular weight. Consequently, the polymer obtainable is as a rule not monodisperse with respect to the property of molecular weight but usually has an associated polydispersity index PDI of ≧2 (PDI=\overline{M}_{w}/\overline{M}ₙ, where \overline{M}_{w}= weight average molecular weight and \overline{M}ₙ= number average molecular weight). This is presumably attributable in particular to chain termination reactions due to irreversible combination of growing free radical polymerization chain ends and also to chain transfer reactions, disproportionation and elimination.

A further disadvantage of the classical free radical polymerization is that, when the monomers to be polymerized are changed during the polymerization, segmented copolymers (block polymers) are generally not obtained. For example, a change of monomers in the emulsion polymerization leads to core/shell polymer particles whose core is composed of one monomer type and whose shell is composed of the other monomer type, core and shell being bound to one another essentially not chemically but only physically. The phase adhesion of the shell to the core is accordingly insufficient in many cases in classical free radical polymerization.

It is known from the prior art that free radical polymerization can be controlled when free radical polymerizations are carried out in the presence of a stable N-oxyl radical (essentially having no initiating effect). For example, the application DE-A-19 803 098 with the earlier priority discloses free radical aqueous emulsion polymerizations using stable N-oxyl radicals.

According to Y. Yang et al., Macromolecules 32 (1999), 7012-7014, the reaction rate of the free radical polymerization in the presence of stable N-oxyl radicals can be increased by using 4-methacryloyloxy-2,2,6,6-tetramethyl-1-piperidinyloxy (MTEMPO) without the polydispersity of the resulting polymers being substantially increased. In the polymerization, the MTEMPO acts both as a stable radical and as a monomer which is consumed during the polymerization. The shear viscosities and uses of the polymers obtained are not disclosed.

The non-prior-published application DE 198 58 098.3 likewise relates to an increase in the reaction rate of the free radical polymerization in the presence of stable N-oxyl radicals by using stable N-oxyl radicals which have polymerizable double bonds, in particular 4-methacryloyloxy-2,2,6,6-tetramethyl-1-piperidinyloxy (MTEMPO). In this application, too, neither the shear viscosities nor uses of the polymers obtained are disclosed.

The presumable mechanism of the free radical polymerization in the presence of stable N-oxyl radicals which have polymerizable double bonds is presumably that the stable N-oxyl radicals do not irreversibly terminate reactive free radical ends of a growing polymer chain at elevated temperatures but merely block them temporarily. This results in a reduction in the steady-state concentration of growing free radical polymer chain ends, which reduces the possibility of irreversible termination of chain growth by combination of two growing polymer chain ends. This leads on average to polymer chains which grow (ideally linearly) with the conversion in the polymerization. The latter results in the resulting polymer having an average molecular weight which grows (ideally linearly) with the conversion of the polymerization and has a polydispersity index PDI which is ideally 1. At the same time, however, a very low polymerization rate results from the reduction in the steady-state concentration of growing free radical polymerization chain ends.

There is a great need for polymers which have a narrow molecular weight distribution and a low shear viscosity in the melt since, depending in each case on their composition, these polymers have excellent processing properties and can therefore be very readily processed to give secondary products.

It is an object of the present invention to provide polymers, in particular polymers having a low shear viscosity in the melt, for processing to give secondary products. Secondary products are to be understood as meaning polymers further processed by appropriate processes.

We have found that this object is achieved by the use of polymers obtainable by a process for the living free radical polymerization of one or more ethylenically unsaturated monomers with the use of at least one free radical polymerization initiator in the presence of one or more stable N-oxyl radicals, at least one stable N-oxyl radical having polymerizable double bonds, for processing to give moldings, films, fibers and foams.

N-Oxyl Radicals

In the polymerization, at least one stable N-oxyl radical which has polymerizable double bonds is used.

The presumable mechanism assumes that, owing to the polymerizable double bonds, the stable N-oxyl radical can participate together with the ethylenically unsaturated monomers in the polymerization. At the same time, the stable N-oxyl radical can temporarily block reactive free radical ends of a growing polymer chain and thus lead to a reduction in the steady-state concentration of growing free radical polymer chain ends and hence reduce the possibility of irreversible termination of chain growth by combination of two growing polymer chain ends. As a result of the polymerization of the stable N-oxyl radicals, the concentration of free stable N-oxyl radicals decreases in the course of the polymerization and fewer polymer chain ends are reversibly blocked. This results in an increase in the reaction rate.

A preferably used stable N-oxyl radical having polymerizable double bonds is a compound of the formula I or II or a mixture thereof

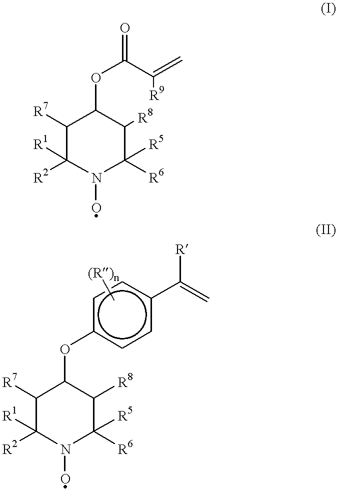

where

R¹, R², R⁵ and R⁶, independently of one another, are identical or different straight-chain or branched, unsubstituted or substituted alkyl groups of 1 to 32 carbon atoms, where R¹ and R² or R⁵ and R⁶ may form a ring system;

R⁷ and R⁸, independently of one another, are

[chemical structure]

M⁺ is a hydrogen ion or an alkali metal ion,

q is an integer from 1 to 10 and

R⁹ in formula I is hydrogen or C₁- to C₈-alkyl and

R′ and R″ in formula II, independently of one another, are hydrogen or C₁- to C₈-alkyl and n is 0, 1, 2 or 3.

Preferably,

R¹, R², R⁵, R⁶ and R⁹ in formula I, independently of one another, are identical or different straight-chain or branched, unsubstituted or substituted alkyl groups of 1 to 3 carbon atoms.

Particularly preferably, R¹, R², R⁵, R⁶ and R⁹ in formula I are methyl groups.

A compound of the formula I where R¹, R², R⁵, R⁶ and R⁹ are each methyl and R⁷ and RR⁸ are each -H is very particularly preferably used.

Accordingly, 4-methacryloyloxy-2,2,6,6-tetramethyl-1-piperidinyloxy (MTEMPO) is particularly preferably used. MTEMPO can be prepared by a process described in T. Kurosaki, J. Polym. Sci.: Polym. Chem. Ed. 10 (1972), 3295.

The stable N-oxyl radical having polymerizable double bonds, particularly preferably MTEMPO, is generally used in a molar amount of from 0.05 to 1%, preferably from 0.1 to 1%, particularly preferably from 0.2 to 0.4%, based on monomer used.

Further suitable stable N-oxyl radicals which can be used together with the stable N-oxyl radical having polymerizable double bonds are all those which have been mentioned in the non-prior-published DE-A-19 803 098 with the earlier priority.

Compounds of the formula III which are derived from a secondary amine may preferably be used as further stable N-oxyl radicals:

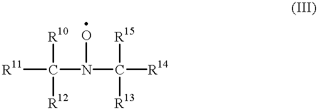

where R¹⁰, R¹¹, R¹⁴ and R¹⁵ are identical or different straight-chain or branched, unsubstituted or substituted alkyl groups and

R¹² and R¹³ are identical or different straight-chain or branched, unsubstituted or substituted alkyl groups or R¹²CNCR¹³ is a part of a cyclic structure with another saturated or aromatic ring which may be fused, the cyclic structure or the aromatic ring being unsubstituted or substituted.

Examples of these are stable N-oxyl radicals of the formula III, in which R¹⁰, R¹¹, R¹⁴ and R¹⁵ are (identical or different) methyl, ethyl, n-propyl, isopropyl, n-butyl, isobutyl, tert-butyl, linear or branched pentyl or phenyl groups or substituted groups thereof and R¹² and R¹³ are (identical or different) methyl, ethyl, n-propyl, isopropyl, n-butyl, isobutyl, tert-butyl or linear or branched pentyl or substituted groups thereof or

if R¹² CNCR¹³ forms a part of a cyclic structure—the cyclic structure

[chemical structure]

where n is an integer from 1 to 10, preferably from 1 to 6, including substituted cyclic groups of these types. Typical examples are 2,2,6,6-tetramethyl-1-oxylpiperidine, 2,2,5,5-tetramethyl-1-oxylpyrrolidine and 4-oxo-2,2,6,6-tetramethyl-1-oxylpiperidine.

The stable N-oxyl radicals can be prepared from the corresponding secondary amines by oxidation, for example with hydrogen peroxide. As a rule, they can be prepared as a pure substance.

Further stable N-oxyl radicals suitable in the process are described in DE-A 19 803 098.

The stable N-oxyl radicals 2,2,6,6-tetramethyl-1-piperidinyloxy (TEMPO), 4-hydroxy-2,2,6,6-tetramethyl-1-piperidinyloxy (HO-TEMPO), di-tert-butyl nitroxide (DTBN), N-tert-butyl-1-phenyl-2-methylpropyl nitroxide and N-tert-butyl-1-diethylphosphono-2,2-dimethylpropyl nitroxide are particularly preferably used.

Mixtures of stable N-oxide radicals may also be used.

A stable N-oxyl radical having polymerizable double bonds is preferably used together with a further N-oxyl radical in the process. A mixture of MTEMPO and the abovementioned particularly preferred nitroxides is particularly preferred.

The amount of MTEMPO in the mixture of N-oxyl radicals is from 10 to 100, preferably from 15 to 100, particularly preferably from 20 to 100, mol %.

Polymerization Initiators

The polymerization is initiated with at least one free radical polymerization initiator. Such compounds are known to those skilled in the art.

For example, organic peroxides, organic hydroperoxides, azo compounds and/or compounds having labile C-C bonds, e.g. 3,4-diphenylhexane, 3,4-demethylhexane, 2,3-dimethylbutane, 2,3-diphenylbutane, and dicumyl peroxide, are used as free radical polymerization initiators.

Dilauryl peroxide and dibenzoyl peroxide are very particularly preferred, especially dibenzoyl peroxide.

Preferred azo compounds are 2,2′-azobis(2-methylbutyronitrile) and 2,2′-azobisisobutyronitrile. 2,2′-Azobisisobutyronitrile is particularly preferred.

Those initiators which have a cyclic structure are also very particularly preferred. Cyclic organic peroxides and cyclic azo compounds are particularly suitable. An example of a cyclic organic peroxide is 3,6,9-triethyl-3,6,9-trimethyl-1,4,7-triperoxononane.

The use of said cyclic initiators makes it possible to prepare polymers having reversibly crosslinked structures.

Thermally initiating monomers, such as styrene or styrene/acrylonitrile mixtures, can also be used as initiators.

Depending on the state of aggregation of the initiator and its solubility behavior, it can be added as such, but is preferably added as a solution, emulsion (liquid in liquid) or suspension (solid in liquid), with the result that in particular small amounts of initiator can be more precisely metered. Suitable solvents or liquid phases for the initiator are organic solvents, such as benzene, toluene, ethylbenzene and cyclohexane, in particular cyclohexane, or the monomers themselves. When the monomers themselves are used as solvent or liquid phase for the initiator, the initiator is dissolved or emulsified/suspended in the total amount of the monomers or preferably in a relatively small proportion of the monomers and this proportion is then added to the remaining components.

It is also possible to dissolve the initiator in the solvent or in the monomers and to disperse the resulting solution in water.

The amount of free radical polymerization initiator is usually from 0.05 to 4, preferably from 0.1 to 2, particularly preferably from 0.15 to 1,% by weight, based on the amount of the monomers.

Usually, the initiators are added immediately before the beginning of the polymerization. However, it is also possible to add the initiator continuously or a little at a time during the polymerization. Of course, a mixture of a plurality of initiators may also be used.

Monomers

Suitable monomers are all ethylenically unsaturated monomers which are capable of free radical polymerization, i.e. can be polymerized in the presence of free radicals.

Examples of suitable monomers having at least one ethylenically unsaturated group are: olefins, such as ethylene or propylene, vinyl aromatic monomers, such as styrene, divinylbenzene, 2-vinylnaphthalene and 9-vinylanthracene, substituted vinyl aromatic monomers, such as p-methylstyrene, α-methylstyrene, o-chlorostyrene, p-chlorostyrene, 2,4-dimethylstyrene, 4-vinylbiphenyl and vinyltoluene, esters of vinyl alcohol and monocarboxylic acids of 1 to 18 carbon atoms, such as vinyl acetate, vinyl propionate, vinyl n-butyrate, vinyl laurate and vinyl stearate, esters of α,β-monoethylenically unsaturated mono- and dicarboxylic acids of 3 to 6 carbon atoms, in particular acrylic acid, methacrylic acid, maleic acid, fumaric acid and itaconic acid, with alkanols of in general 1 to 20, preferably 1 to 12, particularly preferably 1 to 8, very particularly preferably 1 to 4, carbon atoms, in particular methyl, ethyl, n-butyl, isobutyl, tert-butyl and 2-ethylhexyl acrylate and methacrylate, dimethyl maleate or n-butyl maleate, the nitriles of the abovementioned α,β-monoethylenically unsaturated carboxylic acids, such as acrylonitrile and methacrylonitrile, anhydrides, such as maleic anhydride, and conjugated C₄₋₈-dienes, such as 1,3-butadiene and isoprene.

Suitable styrene compounds are those of the formula IV:

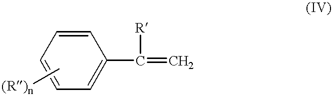

where R′ and R″, independently of one another, are each H or C₁- to C₈-alkyl and n is 0, 1, 2 or 3.

Accordingly, ethylenically unsaturated monomers selected from

styrene compounds of the formula IV,

C₁- to C₂₀-alkyl esters of acrylic acid or methacrylic acid,

dienes having conjugated double bonds,

ethylenically unsaturated dicarboxylic acids and derivatives thereof and

ethylenically unsaturated nitrile compounds

are preferably used in the process.

The monomers styrene, α-methylstyrene, divinylbenzene, vinyltoluene, C₁- to C₈-alkyl (meth)acrylates, in particular n-butyl acrylate, 2-ethylhexyl acrylate or methyl methacrylate, and butadiene, as well as acrylonitrile and monomer mixtures which are composed of at least 85% by weight of the abovementioned monomers or mixtures of the abovementioned monomers are particularly preferably used in the process, very particularly preferably styrene, acrylonitrile, butadiene, n-butyl acrylate, divinylbenzene and methyl methacrylate.

For example, crosslinking monomers may further be present in the preparation of polymers. Crosslinking monomers are bifunctional or polyfunctional comonomers having at least two olefinic double bonds, for example butadiene and isoprene, divinyl esters of dicarboxylic acids, such as succinic acid and adipic acid, diallyl and divinyl ethers, bifunctional alcohols, such as ethylene glycol and butane-1,4-diol, the esters of acrylic acid and methacrylic acid with said bifunctional alcohols, 1,4-divinylbenzene and triallyl cyanurate. The acrylate of tricyclodecenyl alcohol, which is known under the name dibydrodicyclopentadienyl acrylate, and the allyl esters of acrylic acid and of methacrylic acid are particularly preferred.

Additives

Depending on the polymerization process, suitable further additives may be added. In a microsuspension polymerization process, suitable protective colloids may be added, for example for stabilizing the emulsion. Such protective colloids are water-soluble polymers which surround the monomer droplets and the polymer particles formed therefrom and thus protect them from coagulation. Suitable protective colloids are mentioned in DE-A-19 803 098. In emulsion polymerization processes, suitable emulsifiers are furthermore added for stabilizing the emulsion. These are soap-like assistants which surround the monomer droplets and thus protect them from coagulation.

Furthermore, additives which impart specific properties to the polymers may be added. Examples of such additives are polymers, dyes and pigments and ferromagnetic pigments.

The amount of additives is as a rule at least 0. 1, preferably at least 0.5, % by weight, based on the total mass of the mixture.

Carrying out the Polymerization Process

The process is suitable for all known methods of free radical polymerization. The process is preferably carried out as bulk, solution, suspension, microsuspension, emulsion or miniemulsion polymerization, particularly preferably as bulk polymerization. The polymerizations can be carried out continuously or batchwise. The apparatuses used for the polymerization depend on the corresponding polymerization processes. A combination of polymerization processes, e.g. bulk-suspension, is also possible.

The process is carried out at from 60 to 200° C., preferably from 80 to 160° C., particularly preferably from 90 to 140° C. The equilibrium between free polymer chain ends and chain ends reversibly blocked by N-oxyl radicals is temperature-dependent. At elevated temperatures, a larger number of free polymer chain ends is present.

The process is particularly preferably carried out at from 60 to 200° C., very particularly preferably from 80 to 160° C., in particular from 95 to 140° C., and at from 100 mbar to 100 bar.

The present invention furthermore therefore relates to a process for the preparation of polymers for the living free radical polymerization of one or more ethylenically unsaturated monomers with the use of at least one free radical polymerization initiator and in the presence of one or more stable N-oxyl radicals, at least one stable N-oxyl radical having polymerizable double bonds and the process being carried out at from 60 to 200° C., and the use of polymers obtainable by this process for processing to give moldings, films, fibers and foams.

Polymers having a low viscosity in the melt are obtainable by this process. These can be particularly readily processed to give moldings, films, fibers and foams.

Usually, the reaction time is from 1 to 60, preferably from 1.5 to 48, particularly preferably from 2 to 24, hours.

Polydispersities

As a rule, the polydispersity of the polymers obtained is low. In some experiments, however, polymers having a comparatively high polydispersity were also obtained. Polydispersities of up to 1.76 are obtained for systems in which styrene is polymerized in the presence of HO-TEMPO/MTEMPO in the ratio of 1:1, and polydispersities of up to 1.92 in the presence of MTEMPO.

These high polydispersities are presumably attributable to the fact that quasi-branched or quasi-crosslinked polymers can form as a result of incorporation of the MTEMPO radical by polymerization into the polymer to be prepared. Therein, the MTEMPO radicals incorporated by polymerization are free radical acceptors for the free radical polymer chain ends of the growing polymer chain and thus produce branching or crosslinking. This branching or crosslinking is reversible.

The polydispersity of these polymers can be reduced by heating to temperatures of in general from 80 to 200° C., preferably from 90 to 1 60° C., particularly preferably from 100 to 130° C., preferably in the presence of acid, particularly preferably ascorbic acid. For example, polymers having a polydispersity of 1.25 can be obtained after 8 hours by heating prepared polystyrene to 120° C. in the presence of ascorbic acid. Similar effects can be achieved by treatment with free radical acceptors, such as hydroquinone, at the stated temperatures.

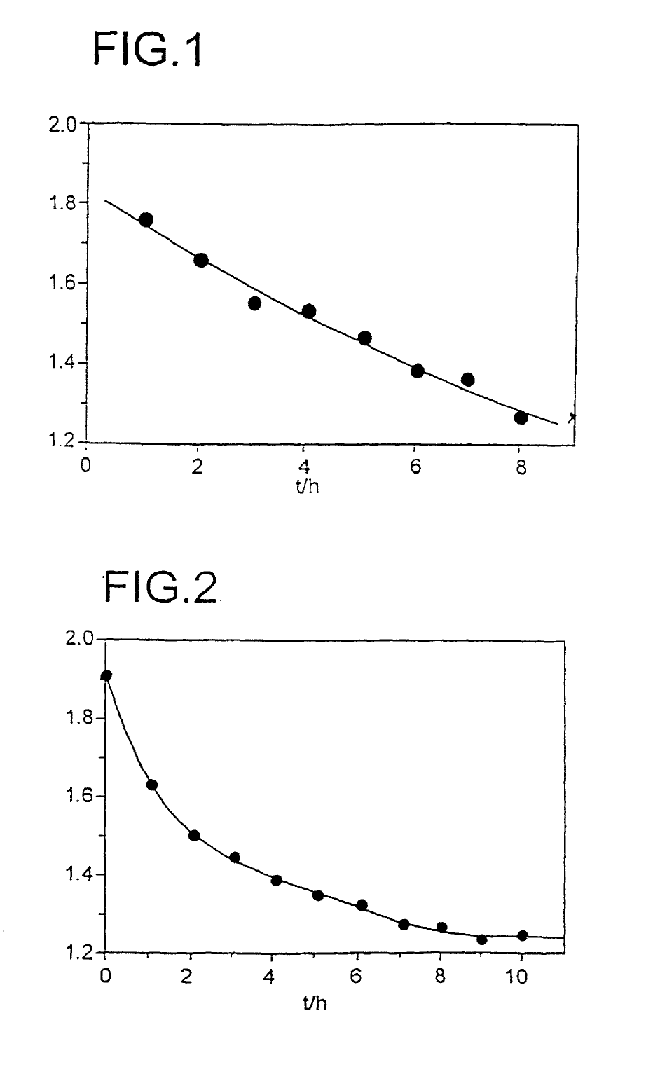

In FIG. 1 and FIG. 2 of the attached drawings, the polydispersity of polystyrene is shown as a function of the reaction time with ascorbic acid at 120° C.

Viscosities

Polymers having a low viscosity are obtainable with the aid of the process for the living free radical polymerization of one or more ethylenically unsaturated monomers with the use of at least one free radical polymerization initiator and in the presence of one or more stable N-oxyl radicals, at least one stable N-oxyl radical having polymerizable double bonds.

Processing of the Polymers

The polymers stated in the present application are used, according to the invention, for processing to give moldings, films, fibers and foams. The rheological and thermal behavior are critical for the performance characteristics and processing properties. To ensure processing as far as possible without problems, it is important to keep the viscosity in the melt low so that the polymers stated in the present application and having a low viscosity are particularly suitable.

In general, additives which are useful for modifying the basic properties (modifiers, plasticizers, fillers and reinforcing materials, flameproofing agents, antistatic agents, dyes, pigments, etc.) or for carrying out the processing in a trouble-free manner (stabilizers, lubricants, mold release agents, etc.) are added to the polymers before they are processed to give moldings, films, fibers and foams. The polymers stated in the application can also be used as a mixture with other polymers, such as polyethylene terephthalate (PET), polybutylene terephthalate (PBT), polycarbonate (PC), polyamide (PA 6), polyamide 66 (PA 66), polyamide 12 (PA 12), polyamide 4,6 (PA 4,6), copolyamides, polypropylene oxide (PPO), polyoxymethylene (POM), polysulfone, polysulfide, polyethersulfone, polyacrylates, polyetherimides, polyetherketones, polyimides, acrylonitrile/butadiene/styrene (polymers) (ABS), acrylonitrile/styrene/acrylate (polymers) (ASA), poly(amidoimides), polybutadiene, poly(meth)acrylates, epoxy resins, polyethylene (PE), polypropylene (PP), EPDM (ethylene propylene diene monomer rubber), copolymers of α-olefins, polyvinyl chloride, (PVC), polymethyl methacrylate (PMMA), polystyrene (PS), styrene/acrylonitrile copolymers (SAN), polyvinyl alcohol, polyvinyl acetate, thermoplastic polyurethane elastomers (TPU), polylactide and polymers described in Chapter 6 of the Polymer Handbook, 3rd ed., Brandrup, J. and Immergut, E H, published by John Wiley and Sons, 1989, New York, and their mixtures and copolymers and block copolymers. Further suitable additives and polymers are known to those skilled in the art.

a) Compounding

The additives and further polymers are generally introduced together with the polymers stated in the application by compounding, i.e. preparation, prior to processing, and the starting materials are converted into a form ready for processing. Suitable compounding processes are mixing, if necessary subsequent treatment in a roll mill and kneading (plasticating) and, if required, subsequent granulation.

b) Processing

The moldings, films, fibers and foams can be produced by various methods. In general, the polymers stated in the present application can be processed by means of any conventional method to give moldings, films, fibers and foams. Suitable methods are stated below.

Processing Methods at Atmospheric Pressure

Suitable processing methods at atmospheric pressure which are suitable, for example, for processing low-viscosity melts are casting, for example monomer casting and film casting, dipping, for example paste dipping, spreading and expansion.

Processing Under Pressure

In processing under pressure, a melt is first produced by the action of heat and then molded and set by cooling. Suitable processing methods under pressure are pressing as well as rolling and calendering, multistage rolling mill with additional apparatuses being required for shaping (melt rolling methods, calendering), extrusion, by means of which, for example, continuous semifinished products, such as pipes, tubes, profiles, sheets, films, wire sheets, monofils, etc. and, by extrusion blow molding methods, hollow articles can be produced, blow molding methods for the production of closed hollow articles (e.g. toys) or hollow articles open at one end (e.g. bottles, containers) from tubular parisons, for example the abovementioned extrusion blow molding method and injection blow molding method. A further important processing method under pressure is injection molding, by means of which a large number of complicated shapes can be produced.

Processing is preferably effected by extrusion, blow molding and injection molding, particularly preferably by injection molding.

During processing of polymers by extrusion or blow molding methods, it is advantageous if the polymers used have a low shear viscosity in the melt, i.e. the shear viscosity of the polymers during melting in the extruder at high temperatures is low. In contrast, the shear viscosity at lower temperatures when the molding material leaves the extruder should be of conventional order of magnitude.

During processing of the polymers stated in the present application by injection molding, it is advantageous if the polymers have a low viscosity in the melt. Such polymers are obtainable by the process disclosed in the present application. The shear viscosity in the melt of the polymers prepared by living free radical polymerization in the presence of N-oxyl radicals which have polymerizable double bonds is lower than that of the corresponding polymers which were polymerized in the presence of N-oxyl radicals which have no polymerizable double bonds, as shown by the results in Table 2.

c) Shaping

The processing can, if required, be followed by a conversion process. Non-cutting shaping of semifinished products by application of external forces and heat serves for increasing the strength or for changing the shape. Suitable conversion processes are, for example, orientation (stretching) and thermoforming, e.g. deep drawing, by means of which semifinished products in the form of sheets and films can be shaped. Shaping is preferably carried out by deep drawing.

The polymers obtainable by a process for the living free radical polymerization of one or more ethylenically unsaturated monomers with the use of at least one free radical polymerization initiator and in the presence of one or more stable N-oxyl radicals, at least one stable N-oxyl radical having polymerizable double bonds, are preferably used for processing to give moldings, films, fibers and foams selected from semifinished products, such as pipes, tubes, profiles, sheets, films, wire sheets and monofils, hollow articles, such as closed hollow articles (e.g. toys) or hollow articles open at one end (e.g. bottles, containers), and complicated shapes. The polymers are particularly preferred for processing to give moldings having long flow distances, e.g. loudspeaker covers, exterior bodywork parts, e.g. hub caps, toys for children, massage apparatuses and housings therefor, medical equipment, equipment for information processing and transmission, housings for garden equipment, extensive wall elements, transport containers, housings for electrical appliances, moldings for the construction sector and grating covers. Of particular interest are shaped articles where low melt viscosity during processing is preferred.

The Examples which follow illustrate the invention.

### EXAMPLES

1. Polymerization Rates of Polymerizations of Methyl Methacrylate and Styrene Which are Carried out in the Presence of MTEMPO and Comparative Experiments

### Example: Polymerization of Methyl Methacrylate

(Samples I to VI, Comparative Samples VII, VIII)

Living free radical polymerization of methyl methacrylate using polymerizable TEMPO derivatives as stable free radicals

MTEMPO and HO-TEMPO (0.0015 mol altogether) are dissolved in different mixing ratios stated in Table 1 in 50 g (0.5 mol) of degassed methyl methacrylate while stirring. The mixture was heated to 100° C. and 0.246 g (0.0015 mol) of AIBN was added to initiate the polymerization in a nitrogen atmosphere. The molar concentration ratios at the beginning (t=0) were: [AIBN]₀=0.3% [MMA]₀, [HO-TEMPO]₀+[MTEMPO]₀: [AIBN]₀=1:1. After various reaction times (cf. Table 1), samples were taken and quenched in liquid nitrogen to stop the polymerization.

The conversion in % was measured using an NETZCH T6 209 apparatus. The samples were heated in nitrogen at a rate of 20 K min⁻¹from 25° C. to 275° C. The weight loss above 275° C. gave the polymer fraction or the monomer conversion.

The molecular weights were determined by gel permeation chromatography on samples taken directly from the mixture. The analysis was carried out with tetrahydrofuran as eluent at a flow rate of 1 ml/min by means of three Waters Ultrastyragel columns HR4, HR3 and HR1 connected in series and a Waters 410 RI detector.

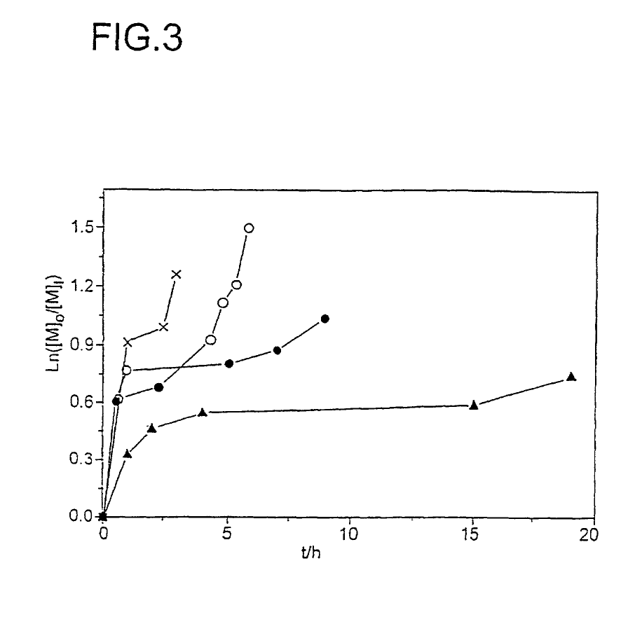

The experimental results are shown in Table 1 and FIG. 3 of the attached drawings.

TABLE 1
Polymerization of methyl methacrylate in the presence of a mixture of
TEMPO derivatives as stable free radicals

| | MTEMPO/ | | | | | |
|---|---|---|---|---|---|---|
| | HO- | | | | | |
| | TEMPO | Conver- | | Mₙ | M_{w} | |
| Sample | [mol %] | sion [%] | Time [h] | (x 10⁻³) | (x 10⁻³) | PD |
| I | 7:3 | 60.2 | 1 | 23.7 | 36.8 | 1.55 |
| II | 7:3 | 71.8 | 3 | 23.7 | 34.6 | 1.46 |
| III | 1:1 | 46.6 | 0.67 | 21.1 | 30.2 | 1.43 |
| IV | 1:1 | 71.9 | 6.2 | 21.0 | 30.8 | 1.47 |
| V | 2:8 | 54.0 | 1 | 20.6 | 30.6 | 1.48 |
| VI | 2:8 | 60.8 | 21 | 20.1 | 30.1 | 1.50 |
| VII | HO-TEMPO | 28.4 | 4 | 18.9 | 27.8 | 1.47 |
| | only | | | | | |
| VIII | HO-TEMPO | 60.9 | 32 | 19.3 | 27.0 | 1.40 |
| | only | | | | | |

The polymerization rate increases significantly with an increase in the MTEMPO/HO-TEMPO ratio, whereas the polydispersity changes only slightly.

### Example: Polymerization of Styrene

Living free radical polymerization of styrene using polymerizable TEMPO derivatives as stable free radicals

The polymerization is carried out similarly to that in Example 1, except that styrene is used instead of methyl methacrylate and polymerization is effected at 120° C.

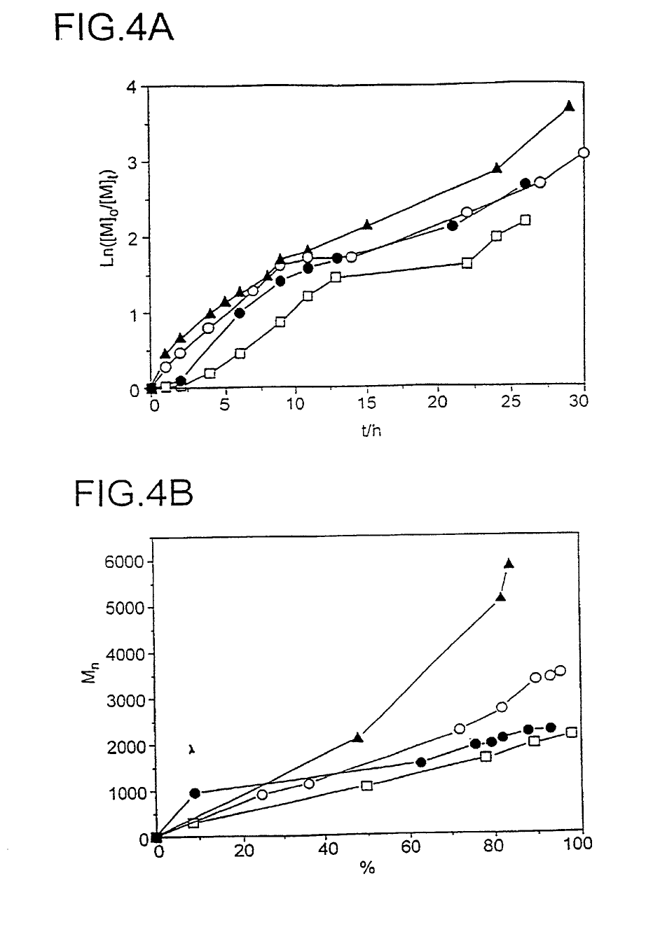

The experimental results are shown in FIG. 4a and FIG. 4b.

The results show that the polymerization rate of a system in which a stable free radical having polymerizable double bonds is used is a factor of about 2 faster than systems in which only a stable free radical without polymerizable double bonds is used.

FIG. 1 shows the polydispersity of polystyrene as a function of the reaction time with ascorbic acid at 120° C. in the presence of HO-TEMPO and MTEMPO in the ratio of 1:1

The polydispersity is plotted along the ordinate and the reaction time in hours along the abscissa.

FIG. 2 shows the polydispersity of polystyrene as a function of the reaction time with ascorbic acid at 120° C. in the presence of MTEMPO

The polydispersity is plotted along the ordinate and the reaction time in hours along the abscissa.

FIG. 3 shows the experimental results from Example 1

Kinetic plot for the living free radical polymerization of methyl methacrylate at 100° C.

Ln([M]₀/[M]ₜ) is plotted along the ordinate, where [M]₀ is the monomer concentration at polymerization time 0 h and [M]ₜ is the monomer concentration at polymerization time t h, and the reaction time in hours [h] is plotted along the abscissa.

The meanings are as follows therein:

Crosses: Plot for a molar ratio MTEMPO:HO-TEMPO=7:3

Open circles: Plot for a molar ratio MTEMPO:HO-TEMPO=1:1

Solid circles: Plot for a molar ratio MTEMPO:HO-TEMPO=2: 8

Triangles: HO-TEMPO only (Comparative Example)

FIG. 4a shows the experimental results from Example 2

Kinetic plot for the living free radical polymerization of styrene at 120° C.

Ln([M]₀/[M]ₜ) is plotted along the ordinate, where [M]₀ is the monomer concentration at polymerization time 0 h and [M]ₜ is the monomer concentration at polymerization time t h, and the reaction time in hours [h] is plotted along the abscissa.

FIG. 4b shows the molecular weight as a function of the conversion in the living free radical polymerization of styrene at 120° C.

The molecular weight Mₙ (measured by gel permeation chromatography) is plotted along the ordinate and the conversion in % along the abscissa.

In FIG. 4a and FIG. 4b, the meanings are as follows:

Solid circles: Plot for a molar ratio HO-TEMPO:benzyl peroxide (BPO)=1:1

Open squares: Plot for a molar ratio HO-TEMPO:benzyl peroxide (BPO)=1.2:1

Open circles: Plot for a molar ratio MTEMPO:HO-TEMPO=1:1 and total TEMPO:BPO=1:1

Triangles: MTEMPO only, molar ratio of MTEMPO:BPO=1:1

2. Shear Viscosities of Styrene Polymers Which Were Prepared in the Presence of MTEMPO and Comparative Experiments

### Example: Preparation of Styrene Polymers

(Sample IX and Comparative Sample X)

The starting materials stated in Table 2 are weighed into glass bomb tubes. The bomb tubes are provided with an inert atmosphere, frozen, sealed and inserted into metal sleeves. The protective sleeves are immersed in an oil bath which already maintains the reaction temperature and polymerization is effected. The reaction conditions are chosen so that polymers having a comparable weight average molecular weight are obtained.

In Table 2, Example X is a comparative example in which 2,2,6,6-tetramethylpiperidinyl-N-oxyl (TEMPO) was used as the stable N-oxyl radical. The reaction temperature in Comparative Example X is 110° C. and the reaction time is 4 hours.

Example IX is according to the invention (use of 4-methacryloyloxy-2,2,6,6-tetramethylpiperidinyl-N-oxyl (MTEMPO)). The reaction temperature in Example IX is 125° C. and the reaction time is 24 hours.

TABLE 2
Polymerization of styrene/acrylonitrile in the presence of TEMPO
derivatives as stable free radicals

| | | | | | | | | | | Shear |
|---|---|---|---|---|---|---|---|---|---|---|
| | | | | | | | | | Vis- | fre- |
| | Sty- | Acrylo- | TEM | MTEM | Ethyl- | | Mw⁵⁾ | | cosity | quency |
| | rene | nitrile | PO | PO | benzene | BPO | [g/ | | η⁷ | ω [rad/ |
| Sample | [g ] | [g ] | [g ]²⁾ | [g ]³⁾ | [g ] | [g ]⁴⁾ | mol] | PDI⁶⁾ | [Pa · s] | s] |
| IX | 75 | 25 | 0 | 0.716 | 50 | 0.412 | 74000 | 3.0 | 1.1 · 10⁴ | 10⁻¹ |
| | | | | | | | | | 1.0 · 10⁴ | 10⁰ |
| | | | | | | | | | 7.3 · 10³ | 10¹ |
| X¹⁾ | 75 | 27 | 0.173 | 0 | 0 | 0.294 | 68000 | 2.3 | 6.8 · 10⁴ | 10⁻¹ |
| | | | | | | | | | 4.1 · 10⁴ | 10⁰ |
| | | | | | | | | | 1.3 · 10⁴ | 10¹ |

¹⁾Comparative Example
²⁾2,2,6,6-Tetramethylpiperidinyl-N-oxyl
³⁾4-Methacryloyloxy-2,2,6,6-tetramethylpiperidinyl-N-oxyl
⁴⁾Dibenzoyl peroxide
⁵⁾Mean molecular weight (weight average), measured by means of gel permeation chromatography
⁶⁾Polydispersity index
⁷⁾Complex shear viscosity (measured by means of mechanical spectroscopy (parallel plate-plate geometry); ISO standard: 6721)

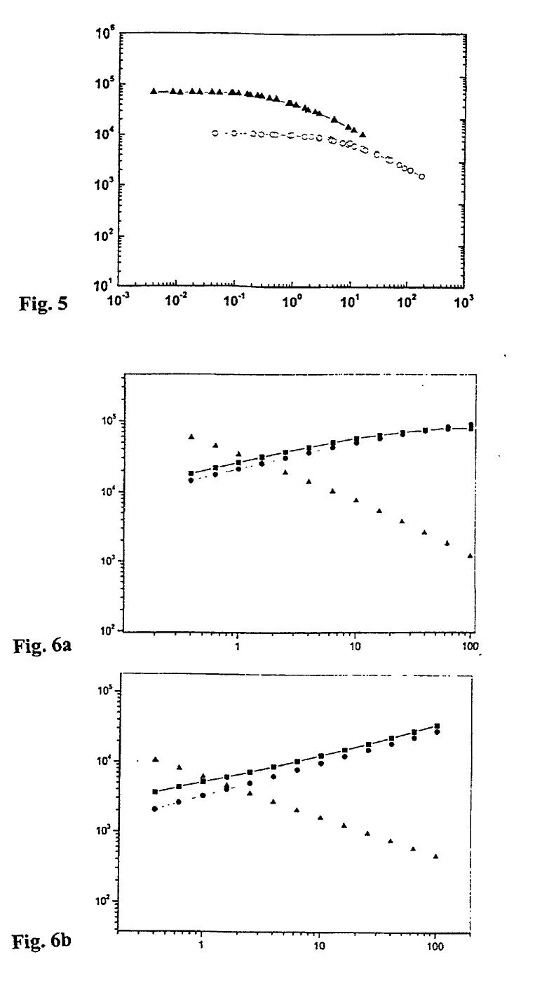

FIG. 5 of the attached drawings shows the viscosities η of the samples IX and X as a function of the shear frequency ω. The viscosity η in Pa·s is plotted along the ordinate and the shear frequency ω in rad/s along the abscissa.

The meanings are as follows:

Solid triangles: Plot of the data of Comparative Example X;

Open circles: Plot of the data of novel Example IX.

It is evident from Table 2 that the shear viscosity of the sample of the Comparative Example is higher by a power of 10 than that of the sample of the novel example. This difference is due to the novel reversibly branched or crosslinked structure.

### Example: Preparation of Styrene Polymers (in the Presence of Divinylbenzene)

(Samples XI, XII, XIII)

A solution of styrene, divinylbenzene (both freshly distilled), dibenzoyl peroxide (recrystallized from chloroform and methanol) and MTEMPO was flushed with nitrogen for about half an hour and degassed in two freezing/thawing cycles. The solution was then heated to 120° C. under a nitrogen atmosphere. The samples were extracted and were precipitated in methanol. The product was dried overnight under reduced pressure at 50° C.

TABLE 3

| | Styrene | DVB¹⁾ | BPO²⁾ | MTEMPO³⁾ |
|---|---|---|---|---|
| Sample | [g] ([mol]) | [g] ([mmol]) | [g] ([mmol]) | [g] ([mmol]) |
| XI | 20.8 (0.2) | 0.079 (0.6) | 0.145 (0.6) | 0.144 (0.6) |
| XII | 20.8 (0.2) | 0.079 (0.6) | 0.145 (0.6) | 0.187 (0.78) |
| XIII | 20.8 (0.2) | 0.13 (0.9) | 0.145 (0.6) | 0.187 (0.78) |

| | Temperature | Shear frequency | Viscosity η⁴⁾ |
|---|---|---|---|
| Sample | [° C.] | ω [rad/s] | [Pa · s] |
| XI | 140 | 10⁰ | 3.3 · 10⁴ |
| | | 10¹ | 1.1 · 10³ |
| | 180 | 10⁰ | 6.1 · 10³ |
| | | 10¹ | 4.4 · 10² |

| | |
|---|---|
| XII | not determined |
| XIII | not determined |

¹⁾Divinylbenzene
²⁾Dibenzoyl peroxide
³⁾4-Methacryloyloxy-2,2,6,6-tetramethylpiperidinyl-N-oxyl
⁴⁾Complex shear viscosity (measured by means of mechanical spectroscopy (parallel plate-plate geometry))

FIGS. 6a and 6b of the attached drawings show the plot of the storage modulus G′ and of the loss modulus G″ and of the complex shear viscosity η against the shear frequency ω for sample XI at various temperatures (6a: 140° C., 6b: 180° C.).

FIG. 6a shows the plot of G′, G″ and η against the shear frequency ωat 140° C.

FIG. 6b shows the plot of G′, G″ and η against the shear frequency ω at 180° C.

In each case, the storage modulus G′ and the loss modulus G″ in Pa and the complex viscosity η in Pa·s are plotted along the ordinate and the shear frequency ω in rad/s along the abscissa.

The meanings are as follows:

Solid squares: Storage modulus G′

Solid circles: Loss modulus G″

Gray triangles: Complex shear viscosity η

Mechanical spectroscopy,

exact conditions: Plate-plate geometry Diameter 25 mm h=1 mm Shear amplitude γ0.3

Plot of the Dynamic Shear Modulus Against the Shear Frequency

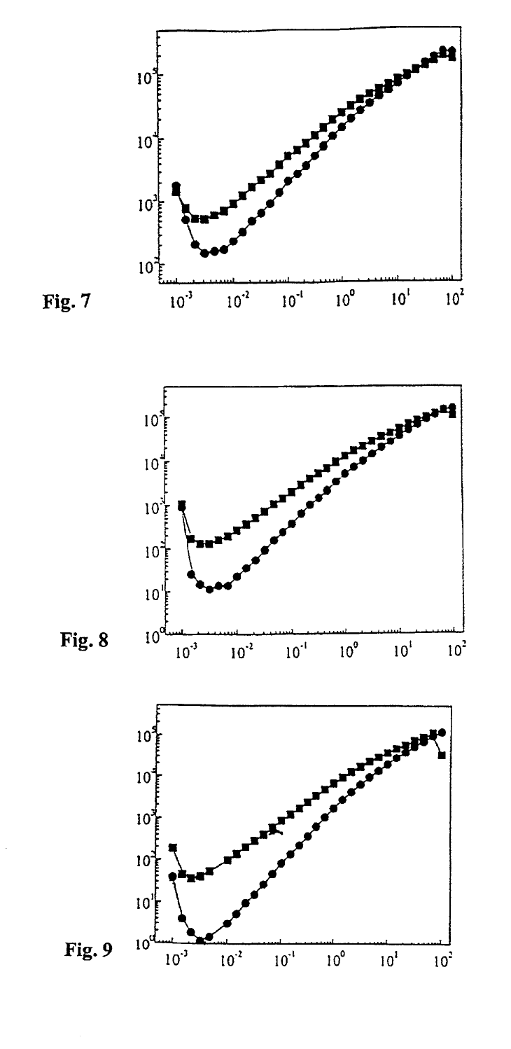

FIGS. 7, 8 and 9 of the attached drawings show plots of the dynamic shear modulus, storage modulus G′ and loss modulus G″ against the shear frequency for polystyrene for sample XIII at various temperatures (FIG. 7: 160° C., FIG. 8: 165° C. and FIG. 9: 170° C.).

The polymer (sample XIII) essentially exhibits the particular behavior of polymers under shear. Both the storage modulus G′ and the loss modulus G″ increase with increasing shear frequency. Interestingly, however, the curve passes, in the region of low shear frequencies, through a minimum which has not been described to date in the case of comparable polymers of the prior art. Furthermore, a comparative experiment without MTEMPO shows typical rheological behavior without a minimum.

FIG. 7 shows the plot of the dynamic shear modulus against the shear frequency at 160° C.

FIG. 8 shows the plot of the dynamic shear modulus against the shear frequency at 165° C.

FIG. 9 shows the plot of the dynamic shear modulus against the shear frequency at 170° C.

In each case, the shear modulus G′ and the loss modulus G″ in Pascal [Pa] are plotted along the ordinate and in each case the frequency in Hertz is plotted along the abscissa for sample XIII.

The meanings are as follows:

Solid squares: Storage modulus G′

Solid circles: Loss modulus G″

3. Methods of Measurement

The rheological properties of the polymers were determined as follows: Sample preparation:

Drying of the polymer powder under reduced pressure for about 16 hours at 80° C.;

Pressing of disk-like samples (diameter 25 mm, height 1 mm) at 190° C.

Measurement of the shear viscosity:

Oscillatory shear measurements were carried out using a commercial rotational rheometer (type SR-5000, Rheometric Scientific) at stress amplitudes of 200 and 300 Pa. The melting time of the samples in the rheometer was 6 minutes. The measurements were carried out in a temperature range from 140 to 200° C. and master curves were prepared at 160° C. by a time-temperature shift. The measurements were carried out from high frequencies to low frequencies.

The experimental results show that the novel polymers have a substantially lower viscosity during processing than conventional polymers of the prior art.

The novel polymers can therefore advantageously be used for

toys for children

massage apparatuses and housings therefor

medical equipment

equipment for information processing and transmission

housings for garden equipment

bodywork parts for vehicles, e.g. hub caps

extensive wall elements

transport containers

housings for electrical appliances

moldings for the construction sector

grating covers

We claim:

1. A process for the production of moldings, films and fibers comprising the step of extruding, blow molding or injection molding a polymer obtainable by a process for the living free radical polymerization of one or more ethylenically unsaturated monomers with the use of at least one free radical polymerization initiator and in the presence of one or more stable N-oxyl radicals, at least one stable N-oxyl radical having polymerizable double bonds

2. The process as claimed in claim 1 for processing for the production of moldings having long flow distances, selected from loudspeaker covers, exterior bodywork parts, toys for children, massage apparatuses, housings for massage apparatuses, medical equipment, equipment for information processing and transmission, housings for garden equipment, extensive wall elements, transport containers, housings for electrical appliances, moldings for the construction sector and grating covers.

3. The process as claimed in claim 1, wherein the process for the living free radical polymerization to obtain the polymer is carried out at from 80 to 200° C.

4. A process for the production of foams comprising the step of expanding a polymer obtainable by a process for the living free radical polymerization of one or more ethylenically unsaturated monomers with the use of at least one free radical polymerization initiator and in the presence of one or more stable N-oxyl radicals, at least one stable N-oxyl radical having polymerizable double bonds.

5. The process as claimed in claim 4, wherein the process of the living free radical polymerization to obtain the polymer is carried out at from 80 to 200° C.

6. A process for the preparation of polymers by living free radical polymerization of one or more ethylenically unsaturated monomers with the use of at least one free radical polymerization initiator and in the presence of one or more stable N-oxyl radicals, at least one stable N-oxyl radical having polymerizable double bonds, wherein the process is carried out at from 80 to 200° C.

7. A polymer obtainable by a process for the living free radical polymerization of one or more ethylenically unsaturated monomers with the use of at least one free radical polymerization initiator and in the presence of one or more stable N-oxyl radicals, at least one stable N-oxyl radical having polymerizable double bonds, wherein the complex shear viscosity of the polymer is low.

8. A polymer as claimed in claim 7, wherein, when plotted against an increasing shear frequency, the storage modulus G′ and the loss modulus G″ have a minimum at shear frequencies of from 10⁻² to 10⁻³ Hertz.
